(19) United States
(12) Patent Application Publication
(10) Pub. No.: US 2006/0236722 A1
(43) Pub. Date: Oct. 26, 2006

(54) Forming apparatus with extensions attached thereto used in a glass manufacturing system

(76) Inventors: Robert Delia, Horseheads, NY (US); Daniel J. Liebner, Corning, NY (US)

Correspondence Address: CORNING INCORPORATED, SP-TI-3-1, CORNING, NY, 14831, US

(21) Appl. No.: 11/115,879

(22) Filed: Apr. 26, 2005

(51) Int. Cl. C03B 5/26; C03B 17/06

(52) U.S. Cl. 65/90; 65/333

(57) ABSTRACT

A glass manufacturing system is described herein that has an elongated forming device (e.g., elongated isopipe) which was made longer by attaching two extensions to two ends of a body so it can be used to make a larger glass sheet. The elongated forming apparatus includes the body and two extensions which when connected to one another have a trough formed therein in which molten glass flows and then overflows two top surfaces of the trough and runs down opposites sides of the body and two extensions before fusing together to form the glass sheet. A method for making glass sheets using the glass manufacturing system and the elongated forming apparatus is also described herein.

### BACKGROUND OF THE INVENTION

1. Field of the Invention

The present invention relates to an elongated forming apparatus (isopipe) that can be used to help manufacture a glass sheet.

2. Description of Related Art

Corning Inc. has developed a process known as the fusion process (e.g., downdraw process) which is the preferred process used today to make high quality thin glass sheets that can be installed in a variety of devices like flat panel displays (LCD displays). The fusion process is preferred because it produces glass sheets whose surfaces have superior flatness and smoothness when compared to glass sheets produced by other methods. An exemplary glass manufacturing system that uses the fusion process to make glass sheets is described next with respect to FIG. 1 (PRIOR ART).

Referring to FIG. 1 (PRIOR ART), there is shown a schematic view of an exemplary glass manufacturing system 100 that uses the fusion process and a traditional forming apparatus 102 (e.g., isopipe 102) to make a glass sheet 155. The glass manufacturing system 100 includes a melting vessel 110, a fining vessel 115, a mixing vessel 120 (e.g., stir chamber 120), a delivery vessel 125 (e.g., bowl 125), the forming apparatus 102, a pull roll assembly 140 and a scoring device 150. As shown, the melting vessel 110 is where glass batch materials 112 are introduced and melted to form molten glass 126. The fining vessel 115 (e.g., finer tube 115) has a high temperature processing area that receives the molten glass 126 (not shown at this point) from the melting vessel 110 and in which bubbles are removed from the molten glass 126. The fining vessel 115 is connected to the mixing vessel 120 (e.g., stir chamber 120) by a finer to stir chamber connecting tube 122. And, the mixing vessel 120 is connected to the delivery vessel 125 by a stir chamber to bowl connecting tube 127. The delivery vessel 125 delivers the molten glass 126 through a downcomer 130 to an inlet 132 and into the traditional forming apparatus 102.

The traditional forming apparatus 102 has a cuneiform/wedge shaped body 104 which has a trough 137 formed therein in which the molten glass 126 flows and then overflows two top surfaces 136a and 136b of the trough 137 and runs down two sides 138a and 138b of the body 104 before fusing together at the bottom of a wedge known as a root 139. The root 139 is where the two sides 138a and 138b come together and where the two overflow walls of molten glass 126 rejoin (e.g., refuse) before being drawn downward by the pull roll assembly 140 to form the glass sheet 155. Then, the scoring device 150 cuts the drawn glass sheet 155 into distinct pieces of glass sheets 155.

Although, the traditional forming apparatus 102 described above works well to form a glass sheet 155, it still has one drawback. The traditional forming apparatus 102 is not long enough to make the large glass sheets which are required today by some customers. To address this drawback, one could make a longer forming apparatus which can be used to make larger glass sheets. Or, one could retrofit the traditional forming apparatus 102 to make it longer so it can be used to make larger glass sheets. A solution related to the last option is the subject of the present invention.

### BRIEF DESCRIPTION OF THE INVENTION

The present invention includes an elongated forming apparatus (e.g., elongated isopipe) which was made longer by attaching two extensions to two ends of a body so it can be used to make a larger glass sheet. The elongated forming apparatus includes the body and two extensions which when connected to one another have a trough formed therein in which molten glass flows and then overflows two top surfaces of the trough and runs down opposites sides of the body and two extensions before fusing together to form the glass sheet. The present invention also includes: (1) a glass manufacturing system that uses the elongated forming apparatus to make glass sheets; and (2) a method for making glass sheets using the glass manufacturing system and the elongated forming apparatus.

### BRIEF DESCRIPTION OF THE DRAWINGS

A more complete understanding of the present invention may be had by reference to the following detailed description when taken in conjunction with the accompanying drawings wherein:

FIG. 1 (PRIOR ART) is a block diagram illustrating an exemplary glass manufacturing system which makes a small glass sheet utilizing a traditional forming apparatus;

FIG. 2 is a block diagram illustrating an exemplary glass manufacturing system which makes a large glass sheet utilizing an elongated forming apparatus in accordance with the present invention;

FIGS. 3A and 3B are respectively an exploded perspective view and a cross-sectional side view of the elongated forming apparatus in accordance with a first embodiment of the present invention;

FIGS. 4A and 4B are respectively an exploded perspective view and a cross-sectional side view of the elongated forming apparatus in accordance with a second embodiment of the present invention;

FIGS. 5A and 5B are respectively an exploded perspective view and a cross-sectional side view of the elongated forming apparatus in accordance with a third embodiment the present invention; and

FIG. 6 is a flowchart illustrating the basic steps of a preferred method for making a glass sheet utilizing the glass manufacturing system shown in FIG. 2 and anyone of the elongated forming apparatuses shown in FIGS. 3-5 in accordance with the present invention.

### DETAILED DESCRIPTION OF THE DRAWINGS

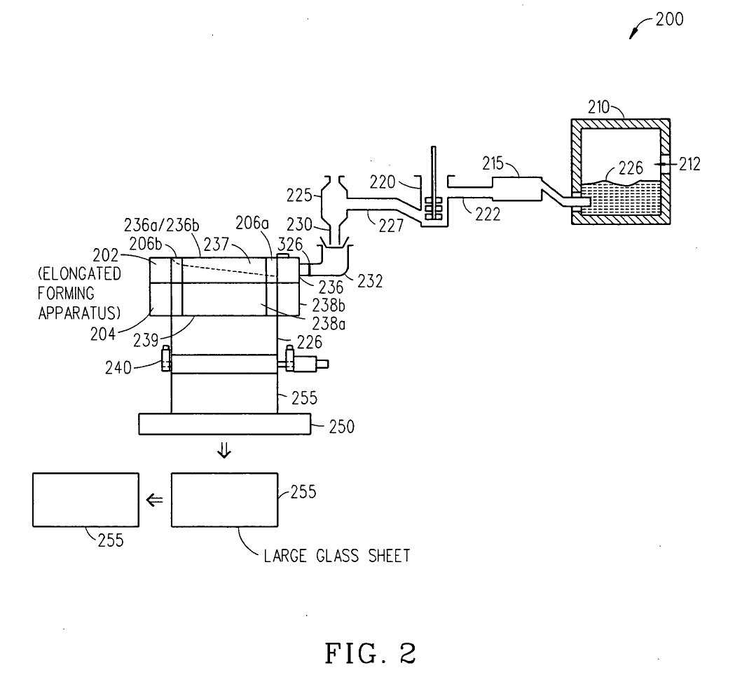

Referring to FIG. 2, there is shown a schematic view of an exemplary glass manufacturing system 200 that uses the fusion process and an elongated forming apparatus 202 (e.g., elongated isopipe 202) to make a glass sheet 255. The glass manufacturing system 200 includes a melting vessel 210, a fining vessel 215, a mixing vessel 220 (e.g., stir chamber 220), a delivery vessel 225 (e.g., bowl 225), the elongated forming apparatus 202, a pull roll assembly 240 and a scoring device 250. As shown, the melting vessel 210 is where glass batch materials 212 are introduced and melted to form molten glass 226. The fining vessel 215 (e.g., finer tube 215) has a high temperature processing area that receives the molten glass 226 (not shown at this point) from the melting vessel 210 and in which bubbles are removed from the molten glass 226. The fining vessel 215 is connected to the mixing vessel 220 (e.g., stir chamber 220) by a finer to stir chamber connecting tube 222. And, the mixing vessel 220 is connected to the delivery vessel 225 by a stir chamber to bowl connecting tube 227. The delivery vessel 225 delivers the molten glass 226 through a downcomer 230 to an inlet 232 and into the elongated forming apparatus 202.

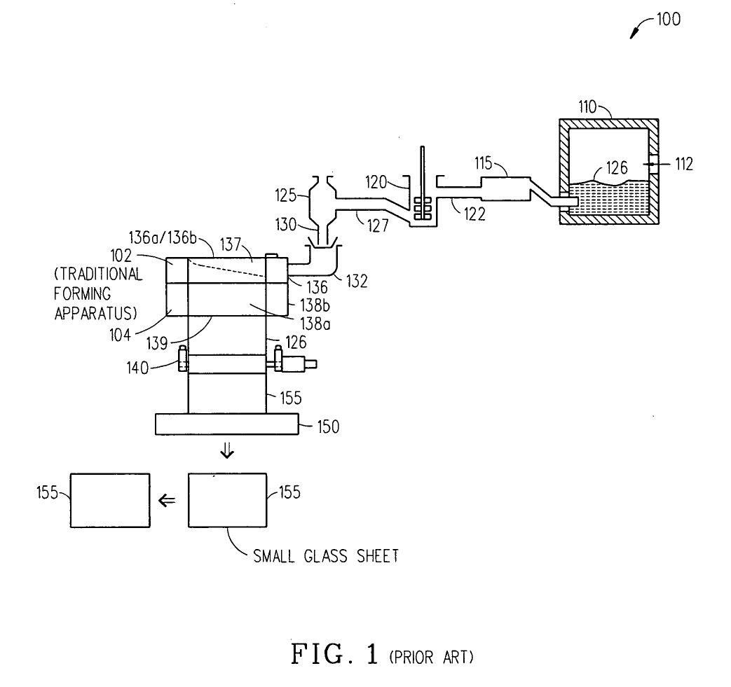

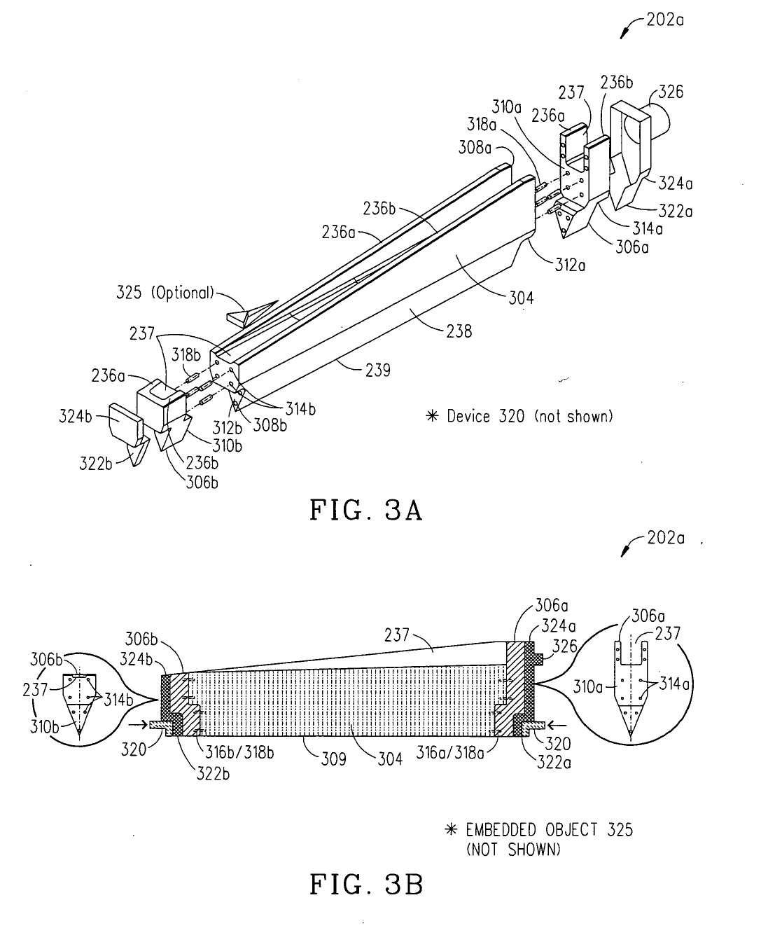

The elongated forming apparatus 202 includes a cuneiform/wedge shaped body 204 and two similarly shaped extensions 206a and 206b (see FIGS. 3-5). The body 204 and the two extensions 206a and 206b when attached to one another have a trough 237 formed therein in which the molten glass 226 flows and then overflows two top surfaces 236a and 236b of the trough 237 and runs down two sides 238a and 238b of the body 204 and two extensions 206a and 206b before fusing together at the bottom of a wedge known as a root 239. The root 239 is where the two sides 238a and 238b come together and where the two overflow walls of molten glass 226 rejoin (e.g., refuse) before being drawn downward by the pull roll assembly 240 to form the glass sheet 255. Then, the scoring device 250 cuts the drawn glass sheet 255 into distinct pieces of glass sheets 255. As can be seen, the elongated forming apparatus 202 enables one to make a glass sheet 255 that is larger than the glass sheet 155 that can be made with the traditional forming apparatus 102 shown in FIG. 1. Three different embodiments of the elongated forming apparatus 202 are described and shown in greater detail below with respect to FIGS. 3-5.

Referring to FIGS. 3A and 3B, there are respectively illustrated an exploded perspective view and a cross-sectional side view of the elongated forming apparatus 202a in accordance with a first embodiment of the present invention. The forming apparatus 202a includes a body 304 and two extensions 306a and 306b. The first extension 306a is attached to one end 308a of the body 304. And, the second extension 306b is attached to the opposite end 308b of the body 304.

As can be seen, the first extension 306a has a mating surface 310a with a geometry configured so it can interface with and be attached to a mating surface 312a on the first end 308a of the body 304. Both mating surfaces 310a and 312a have a series of holes 314a and 316a formed therein in which pins 318a are inserted to attach the first extension 306a to the body 304. Likewise, the second extension 306b has a mating surface 310b with a geometry configured so it can interface with and be attached to a mating surface 312b on the second end 308b of the body 304. As above, both mating surfaces 310b and 312b have a series of holes 314b and 316b formed therein in which pins 318b are inserted to attach the second extension 306b to the body 304.

After, the two extensions 306a and 306b are attached to the body 304, then two end caps 324a and 324b (platinum end caps 324a and 324b) may be attached to the exposed ends of the two extensions 306a and 306b. The first end cap 324a has an opening 326 formed therein through which the molten glass 226 is received (see FIG. 2). If additional mechanical support is needed between the two extensions 306a and 306b and the body 304, then a device 320 (pier block 320) can be used to apply a compressive load between the two extensions 306a and 306b and the body 304 (only shown in FIG. 3B). In the preferred embodiment, the device 320 would interface with pier seats 322a and 322b which are formed within two end caps 324a and 324b.

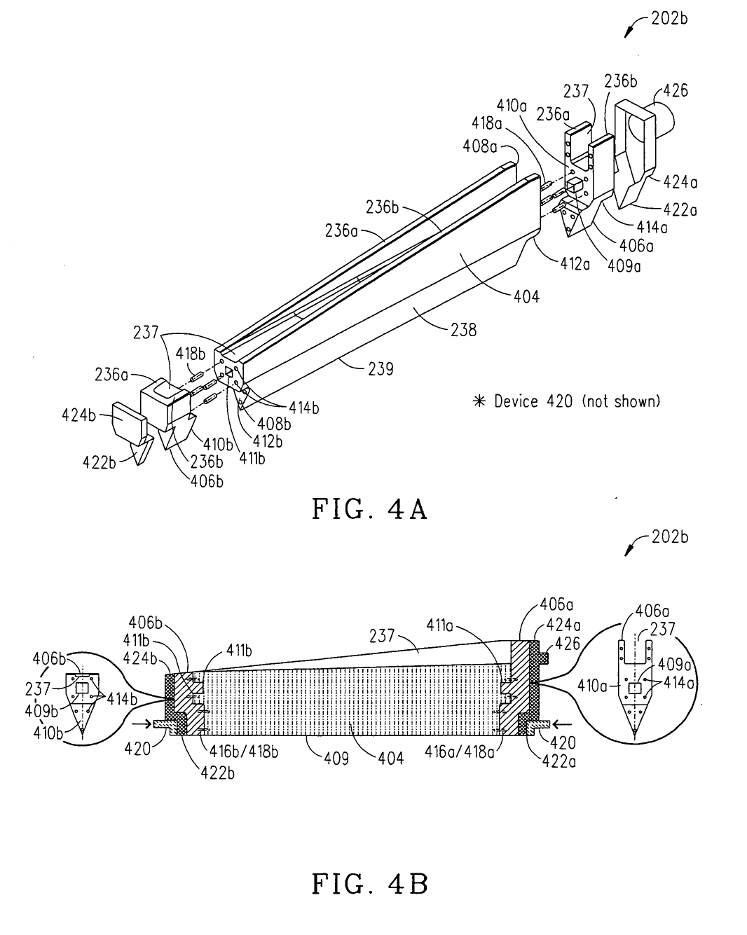

Referring to FIGS. 4A and 4B, there are respectively illustrated an exploded perspective view and a cross-sectional side view of the elongated forming apparatus 202b in accordance with a second embodiment of the present invention. The forming apparatus 202b includes a body 404 and two extensions 406a and 406b. The first extension 406a is attached to one end 408a of the body 404. And, the second extension 406b is attached to the opposite end 408b of the body 404.

As can be seen, the first extension 406a has a mating surface 410a with a geometry configured so it can interface with and be attached to a mating surface 412a on the first end 408a of the body 404. Both mating surfaces 410a and 412a have a series of holes 414a and 416a formed therein in which pins 418a are inserted to attach the first extension 406a to the body 404. To provide even more support, the mating surface 410a has a block 409a that extends therefrom and fits into an opening 411a formed within the mating surface 412a.

Likewise, the second extension 406b has a mating surface 410b with a geometry configured so it can interface with and be attached to a mating surface 412b on the second end 408b of the body 404. And, both mating surfaces 410b and 412b have a series of holes 414b and 416b formed therein in which pins 418b are inserted to attach the second extension 406b to the body 404. To provide even more support, the mating surface 410b has a block 409b that extends therefrom and fits into an opening 411b formed within the mating surface 412b.

After, the two extensions 406a and 406b are attached to the body 404, then two end caps 424a and 424b (platinum end caps 424a and 424b) may be attached to the exposed ends of the two extensions 406a and 406b. The first end cap 424a has an opening 426 formed therein through which the molten glass 226 is received (see FIG. 2). If additional mechanical support is needed between the two extensions 406a and 406b and the body 404, then a device 420 (pier block 420) can be used to apply a compressive load between the two extensions 406a and 408b and the body 404 (only shown in FIG. 4B). In the preferred embodiment, the device 420 would interface with pier seats 422a and 422b which are formed within two end caps 424a and 424b.

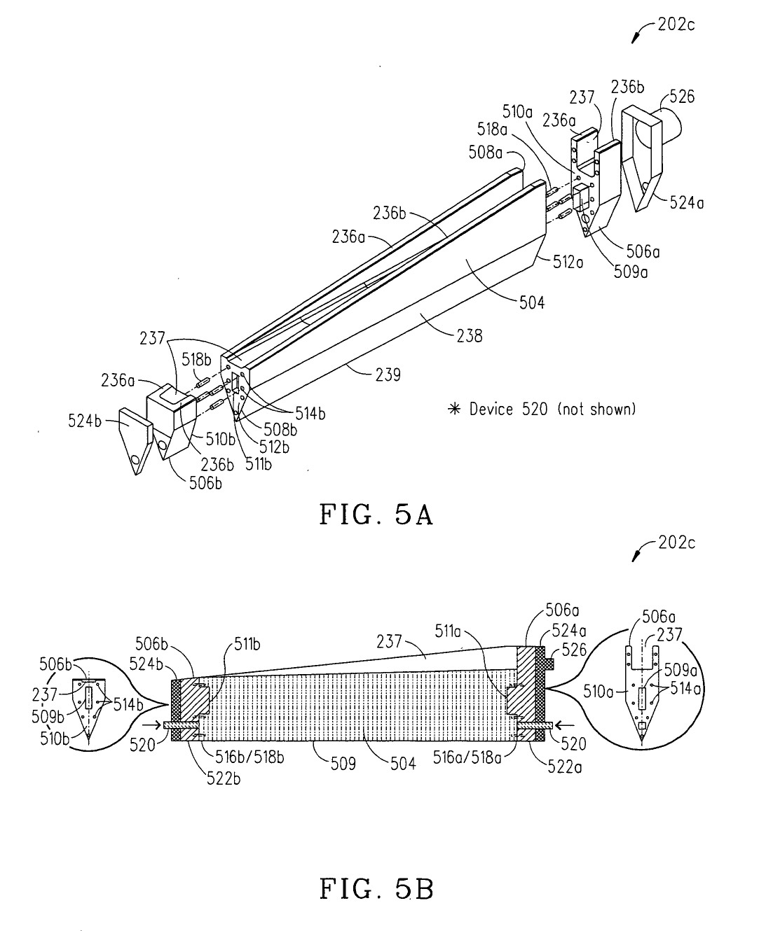

Referring to FIGS. 5A and 5B, there are respectively illustrated an exploded perspective view and a cross-sectional side view of the elongated forming apparatus 202c in accordance with a third embodiment of the present invention. The forming apparatus 202c includes a body 504 and two extensions 506a and 506b. The first extension 506a is attached to one end 508a of the body 504. And, the second extension 506b is attached to the opposite end 508b of the body 504.

As can be seen, the first extension 506a has a mating surface 510a with a geometry configured so it can interface with and be attached to a mating surface 512a on the first end 508a of the body 504. Both mating surfaces 510a and 512a have a series of holes 514a and 516a formed therein in which pins 518a are inserted to attach the first extension 506a to the body 504. To provide even more support, the mating surface 510a has a tongue 509a that extends therefrom and fits into a groove 511a formed within the mating surface 412a.

Likewise, the second extension 506b has a mating surface 510b with a geometry configured so it can interface with and be attached to a mating surface 512b on the second end 508b of the body 504. And, both mating surfaces 510b and 512b have a series of holes 514b and 516b formed therein in which pins 518b are inserted to attach the second extension 506b to the body 504. To provide even more support, the mating surface 510b has a tongue 509b that extends therefrom and fits into a groove 511b formed within mating surface 512b.

After, the two extensions 506a and 506b are attached to the body 504, then two end caps 524a and 524b (platinum end caps 524a and 524b) may be attached to the exposed ends of the two extensions 506a and 506b. The first end cap 524a has an opening 526 formed therein through which the molten glass 226 is received (see FIG. 2). If additional mechanical support is needed between the two extensions 506a and 506b and the body 504, then a device 520 (pier block 520) can be used to apply a compressive load onto the body 504 (compare to FIGS. 3B and 4B). In the preferred embodiment, the device 520 would pass through the two end caps 524a and 524b and the two extensions 506a and 506b to compress the body 504. As can be seen, there are no pier seats in this embodiment.

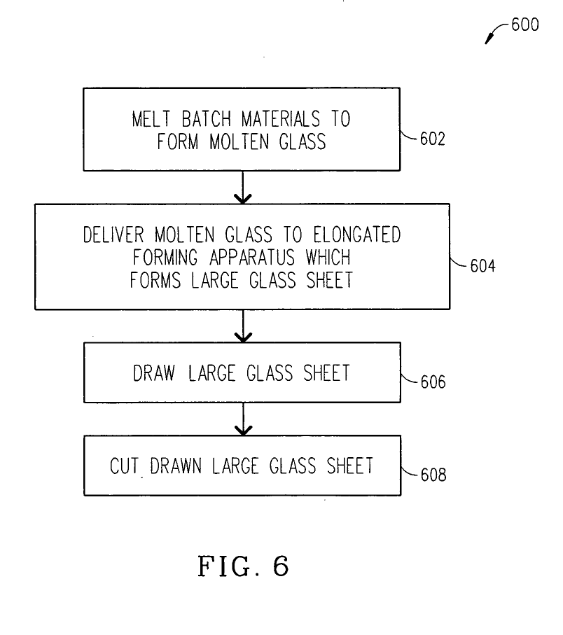

Referring to FIG. 6, there is a flowchart illustrating the basic steps of a preferred method 600 for making a glass sheet 255 utilizing the glass manufacturing system 200 and the elongated forming apparatus 202 in accordance with the present invention (see FIGS. 2-5). Beginning at step 602, the glass manufacturing system 200 and in particular the melting vessel 210, the fining vessel 215, the mixing vessel 220 and the delivery vessel 225 are used to melt batch materials 212 and form molten glass 226 (see FIG. 2). At step 604, the molten glass 226 is delivered to the elongated forming apparatus 202 which forms the glass sheet 255 (see FIGS. 2-5). At step 606, the pull roll assembly 240 draws the sheet glass 255. And, then at step 608, the scoring device 250 cuts the drawn glass sheet 255 into individual glass sheets 255.

Following are some features, advantages and uses of the present invention:
The elongated forming apparatus 202 and the components that make it up like the extensions, the body and the pins can be made from zircon, zirconia, alumina or similar materials. In an alternative embodiment, the pins can be made from a high temperature, high modulus of rupture (MOR) material like, for example, Hexoloy-SiC. This MOR material may be coated with a material that is compatible with the material used to make the extensions and body. * The elongated forming apparatuses 202a, 202b and 202c described and shown herein have extensions with notched-shaped geometries that are designed to interface with corresponding notched shaped ends of the body. It should be appreciated that the extensions and ends of the body can have any type of shape so long as they can be attached to one another.
It should be appreciated that the elongated forming apparatus 202 can use just one extension which is attached to one end of the body even though two extensions attached to both ends of the body are described and shown herein.
The elongated forming apparatus 202 may have a platinum coating or other type of coating which covers the joints between the extensions and the body.
It should be appreciated that the blocks/tongues shown in the extensions of forming apparatuses 202b and 202c can be formed in the bodies 404 and 504 instead.
The elongated forming apparatus 202 may also incorporate an embedded object 325 (plow 325) which is placed on a bottom surface of the trough 237 (only shown in FIG. 3A). The presence of the embedded object 325 is desirable since without the embedded object 325 it can be difficult to size and manufacture the contoured bottom surface of the trough 237 inside the forming apparatus 202. For a more detailed discussion about the embedded object 325 reference is made to U.S. patent application Ser. No. 10/859,248 entitled “Glass Sheet Forming Apparatus” and filed on Jun. 2, 2004. The contents of this patent application are incorporated by reference herein.
It should be appreciated that the glass manufacturing system 200 described herein is exemplary and that other types and configurations of glass manufacturing systems can incorporate and use elongated forming apparatus 202 and method 600 of the present invention.

The fusion process which is described above with respect to FIGS. 1 and 2 is discussed in more detail in U.S. Pat. Nos. 3,338,696 and 3,682,609. The contents of these patents are incorporated herein by reference.

Although several embodiments of the present invention have been illustrated in the accompanying Drawings and described in the foregoing Detailed Description, it should be understood that the invention is not limited to the embodiment disclosed, but is capable of numerous rearrangements, modifications and substitutions without departing from the spirit of the invention as set forth and defined by the following claims.

What is claimed is:

1. A forming apparatus comprising:
a body;
at least one extension, each one of the extensions is attachable to one of two ends of said body; and
said body and said at least one extension when attached to one another together have a trough formed therein in which molten glass flows and then overflows two top surfaces of the trough and runs down opposites sides of said body and said at least one extension before fusing together to form a glass sheet.

2. The forming apparatus of claim 1, wherein:
each extension has a mating surface with a first set of holes located therein; and
each end of said body has a mating surface with a second set of holes located therein, wherein a plurality of pins are inserted into both sets of holes to attach each extension to each end of said body.

3. The forming apparatus of claim 1, wherein:
each extension has a mating surface with a first set of holes located therein and a block extending therefrom; and
each end of said body has a mating surface with a second set of holes located therein and an opening formed therein, wherein a plurality of pins are inserted into both sets of holes and the block is inserted into the opening to attach each extension to each end of said body.

4. The forming apparatus of claim 1, wherein:
each extension has a mating surface with a first set of holes located therein and a tongue extending therefrom; and
each end of said body has a mating surface with a second set of holes located therein and a groove formed therein, wherein a plurality of pins are inserted into both sets of holes and the tongue is inserted into the groove to attach each extension to each end of said body.

5. The forming apparatus of claim 1, wherein:
each extension is made from a selected one of zircon, zirconia and alumina.

6. The forming apparatus of claim 1, wherein:
said trough has a bottom surface on which an embedded object is positioned.

7. The forming apparatus of claim 1, further comprising a device which applies a compressive load to said at least one extension and said body after they are attached to one another.

8. The forming apparatus of claim 1, further comprising at least one end cap that attaches to an exposed end of said at least one extension.

9. A glass manufacturing system comprising:
at least one vessel for melting batch materials and forming molten glass; and
a forming apparatus for receiving the molten glass and forming a glass sheet, wherein said forming apparatus includes:
a body;
at least one extension, each one of the extensions is attachable to one of two ends of said body; and
said body and said at least one extension when attached to one another together have a trough formed therein in which the molten glass flows and then overflows two top surfaces of the trough and runs down opposites sides of said body and said at least one extension before fusing together to form a glass sheet;
a pull roll assembly for receiving the glass sheet and drawing the glass sheet; and
a scoring device for receiving the drawn glass sheet and cutting the drawn glass sheet.

10. The glass manufacturing system of claim 9, wherein:
each extension has a mating surface with a first set of holes located therein; and
each end of said body has a mating surface with a second set of holes located therein, wherein a plurality of pins are inserted into both sets of holes to attach each extension to each end of said body.

11. The glass manufacturing system of claim 9, wherein:
each extension has a mating surface with a first set of holes located therein and a block extending therefrom; and
each end of said body has a mating surface with a second set of holes located therein and an opening formed therein, wherein a plurality of pins are inserted into both sets of holes and the block is inserted into the opening to attach each extension to each end of said body.

12. The glass manufacturing system of claim 9, wherein:
each extension has a mating surface with a first set of holes located therein and a tongue extending therefrom; and
each end of said body has a mating surface with a second set of holes located therein and a groove formed therein, wherein a plurality of pins are inserted into both sets of holes and the tongue is inserted into the groove to attach each extension to each end of said body.

13. The glass manufacturing system of claim 9, wherein said forming apparatus further includes a device which applies a compressive load to said at least one extension and said body after they are attached to one another.

14. The glass manufacturing system of claim 9, wherein said forming apparatus further includes at least one end cap that attaches to an exposed end of said at least one extension.

15. The glass manufacturing system of claim 9, wherein said at least one vessel includes a melting, fining, mixing or delivery vessel.

16. A method for producing a glass sheet, said method comprising the steps of:
melting batch materials to form molten glass;
delivering the molten glass to a forming apparatus which forms the glass sheet, said forming apparatus includes:
a body;
at least one extension, each one of the extensions is attachable to one of two ends of said body; and
said body and said at least one extension when attached to one another together have a trough formed therein in which the molten glass flows and then overflows two top surfaces of the trough and runs down opposites sides of said body and said at least one extension before fusing together to form the glass sheet;
drawing the glass sheet; and
cutting the drawn glass sheet.

17. The method of claim 16, wherein:
each extension has a mating surface with a first set of holes located therein; and
each end of said body has a mating surface with a second set of holes located therein, wherein a plurality of pins are inserted into both sets of holes to attach each extension to each end of said body.

18. The method of claim 16, wherein:
each extension has a mating surface with a first set of holes located therein and a block extending therefrom; and
each end of said body has a mating surface with a second set of holes located therein and an opening formed therein, wherein a plurality of pins are inserted into both sets of holes and the block is inserted into the opening to attach each extension to each end of said body.

19. The method of claim 16, wherein:
each extension has a mating surface with a first set of holes located therein and a tongue extending therefrom; and
each end of said body has a mating surface with a second set of holes located therein and a groove formed therein, wherein a plurality of pins are inserted into both sets of holes and the tongue is inserted into the groove to attach each extension to each end of said body.

20. The method of claim 16, wherein said forming apparatus further includes a device which applies a compressive load to said at least one extension and said body after they are attached to one another.

21. The method of claim 16, wherein said forming apparatus further includes at least one end cap that attaches to an exposed end of said at least one extension.
